(19) United States
(12) Patent Application Publication
(10) Pub. No.: US 2022/0219474 A1
(43) Pub. Date: Jul. 14, 2022

(54) PRINTER, CONTROL METHOD, AND NON-TRANSITORY COMPUTER-READABLE MEDIUM STORING COMPUTER-READABLE INSTRUCTIONS

(71) Applicant: BROTHER KOGYO KABUSHIKI KAISHA, Nagoya (JP)

(72) Inventor: Yugo FUKUI, Kariya (JP)

(21) Appl. No.: 17/705,625

(22) Filed: Mar. 28, 2022

Related U.S. Application Data
(63) Continuation of application No. PCT/JP2021/006324, filed on Feb. 19, 2021.

(30) Foreign Application Priority Data
Feb. 26, 2020 (JP) 2020-030772

(51) Int. Cl. B41M 5/00

(52) U.S. Cl. CPC B41M 5/0011

(57) ABSTRACT

A processor of a printer determines whether execution of wet-on-wet printing, which is printing wet-on-wet with ink onto a print medium to which a pretreatment agent has been applied by a pretreatment portion applying the pretreatment agent to the print medium, is able to be completed. The processor performs first processing of printing by discharging ink from a print head onto the pretreatment agent that has been applied to the print medium, when it has been determined that execution of the wet-on-wet printing is able to be completed. The processor performs second processing differing from the first processing, when it has been determined that execution of the wet-on-wet printing is unable to be completed.

### CROSS-REFERENCE TO RELATED APPLICATION

This application is a continuation application of International Application No. PCT/JP2021/006324, filed Feb. 19, 2021, which claims priority from Japanese Patent Application No. 2020-030772, filed on Feb. 26, 2020. The disclosure of the foregoing application is hereby incorporated by reference in its entirety.

### BACKGROUND

The present disclosure relates to a printer, a control method, and a non-transitory computer-readable medium storing computer-readable instructions.

A printer applies a pretreatment agent to a print medium before discharging ink in order to improve the fixing of ink discharged onto the print medium. The printer applies a pretreatment agent to fabric, and then discharges ink onto the fabric that is wet with the applied pretreatment agent. As such, wet-on-wet printing is performed.

### SUMMARY

There is a possibility that the pretreatment agent applied to the fabric may evaporate or soak into the fabric over time. With the printer described above, if printing with ink is prohibited due to maintenance or the like when the application of the pretreatment agent is completed, for example, the time from the completion of the application of the pretreatment until the start of printing becomes longer. Also, if the area of the region where ink is to be discharged is large, the time required for printing will be longer. In these cases, the time from the completion of the application of the pretreatment agent until the completion of execution of printing will be longer, so the evaporation amount and the penetration amount into the fabric of the applied pretreatment agent will increase. As a result, there was a possibility that the printer described above would not be able to complete the execution of wet-on-wet printing.

Embodiments of the broad principles derived herein provide a printer, a control method, and a non-transitory computer-readable medium storing computer-readable instructions that easily completes the execution of wet-on-wet printing.

A first aspect of the present disclosure relates to a printer. The printer includes a print head configured to discharge ink onto a print medium, a processor configured to control the print head, and a memory storing computer-readable instructions that, when executed by the processor, cause the processor to perform processes. The processes include performing determination processing of determining whether execution of wet-on-wet printing, which is printing wet-on-wet with the ink onto the print medium to which a pretreatment agent has been applied by a pretreatment portion applying the pretreatment agent to the print medium, is able to be completed. The processes include performing first processing of printing with the ink by discharging the ink from the print head onto the pretreatment agent that has been applied to the print medium, when it has been determined by the determination processing that execution of the wet-on-wet printing is able to be completed. The processes include performing second processing differing from the first processing, when it has been determined by the determination processing that execution of the wet-on-wet printing is unable to be completed.

According to the first aspect, printing in the first processing is executed when it is determined that execution of wet-on-wet printing is able to be completed. On the other hand, when it is determined that execution of wet-on-wet printing is unable to be completed, the second processing will be executed, so printing in the first processing will not be executed. Therefore, the printer easily completes the execution of wet-on-wet printing.

A second aspect of the present disclosure relates to a control method of a printer of a printer provided with a print head configured to discharge ink onto a print medium, and a processor configured to control the print head. The control method includes performing determination processing of determining whether execution of wet-on-wet printing, which is printing wet-on-wet with the ink onto the print medium to which a pretreatment agent has been applied by a pretreatment portion applying the pretreatment agent to the print medium, is able to be completed. The control method includes performing first processing of printing with the ink by discharging the ink from the print head onto the pretreatment agent that has been applied to the print medium, when it has been determined by the determination processing that execution of the wet-on-wet printing is able to be completed. The control method includes performing second processing differing from the first processing, when it has been determined by the determination processing that execution of the wet-on-wet printing is unable to be completed. The second aspect can achieve the same effects as those of the first aspect.

A third aspect of the present disclosure relates to a non-transitory computer-readable medium storing computer-readable instructions that, when executed by a computer of a printer provided with a print head configured to discharge ink onto a print medium, and the computer configured to control the print head, cause the computer to perform processes. The processes include performing determination processing of determining whether execution of wet-on-wet printing, which is printing wet-on-wet with the ink onto the print medium to which a pretreatment agent has been applied by a pretreatment portion applying the pretreatment agent to the print medium, is able to be completed. The processed include performing first processing of printing with the ink by discharging the ink from the print head onto the pretreatment agent that has been applied to the print medium, when it has been determined by the determination processing that execution of the wet-on-wet printing is able be completed. The processes include performing second processing differing from the first processing, when it has been determined by the determination processing that execution of the wet-on-wet printing is unable to be completed. The third aspect can achieve the same effects as those of the first aspect.

### BRIEF DESCRIPTION OF THE DRAWINGS

Embodiments will be described below in detail with reference to the accompanying drawings in which:

FIG. 1 is a block diagram illustrating an electrical configuration of the printer;

FIG. 2 is a schematic diagram of a printing result when normal base printing processing is performed;

FIG. 3 is a flowchart of main processing;

FIG. 4 is a schematic diagram of a printing result when low-resolution base printing processing is performed; and

FIG. 5 is a schematic diagram of a printing result when thinned-out base printing processing is performed.

### DETAILED DESCRIPTION

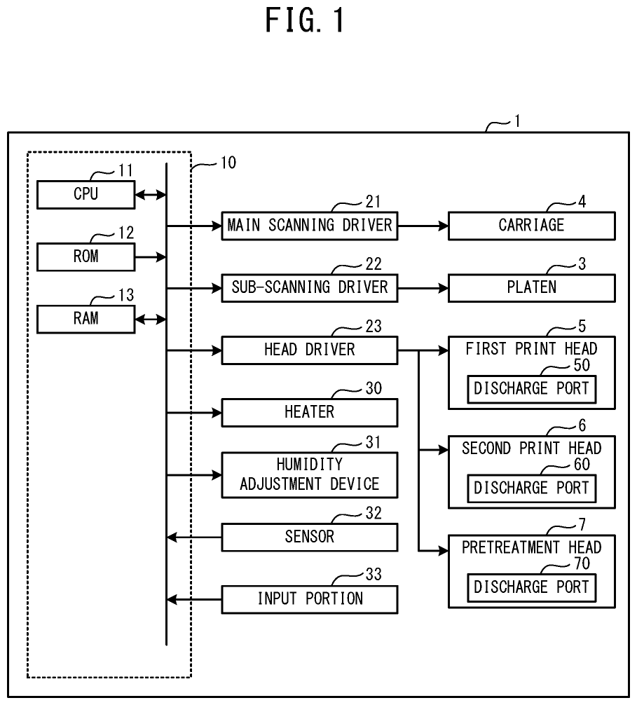

A printer 1 related to one embodiment of the present disclosure will be described with reference to the drawings. The printer 1 shown in FIG. 1 is an inkjet printer, and performs printing by discharging ink onto a print medium 2 of cloth or paper or the like. The printer 1 can print a color image on the print medium 2 using five colors of ink, i.e., white (W), black (K), yellow (Y), cyan (C), and magenta (M).

Hereinafter, of the five colors of ink, the white-colored ink will be referred to as “white ink”, and the other four colors of ink, i.e., black, cyan, yellow, and magenta, will collectively be referred to as “color ink”. When collectively referring to the white ink and the color ink, or when neither is specified, they will simply be referred to as “ink”. The white ink is used for printing a base (hereinafter, referred to as “base printing”) in order to improve the coloring of the color ink. The color ink is discharged on the white ink and is used to print a color image (hereinafter, referred to as “color printing”).

The mechanical structure and the electrical structure of the printer 1 will be described with reference to FIG. 1. The printer 1 includes a platen 3, a carriage 4, a first print head 5, a second print head 6, and a pretreatment head 7. The platen 3 can move in a sub-scanning direction and supports the print medium 2. The sub-scanning direction in the present embodiment is the front-rear direction of the printer 1. The carriage 4 is provided above the platen 3, and can move in a main scanning direction. The main scanning direction of the present embodiment is the left-right direction of the printer 1. The first print head 5, the second print head 6, and the pretreatment head 7 are mounted to the carriage 4.

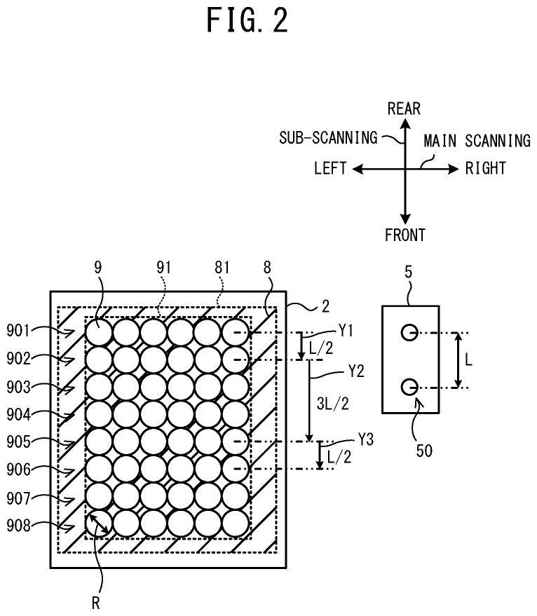

A discharge port 50 is provided on a lower surface of the first print head 5. The discharge port 50 is configured such that a plurality of rows of a plurality of holes lined up in the sub-scanning direction are lined up in the main scanning direction. The first print head 5 discharges the white ink from the discharge port 50 toward the print medium 2 (refer to FIG. 2) on the platen 3. As a result, base printing is performed on the print medium 2. A discharge port 60 is provided in a lower surface of the second print head 6. The discharge port 60 is configured such that a plurality of rows of a plurality of holes lined up in the sub-scanning direction are lined up in the main scanning direction. Each row of holes of the discharge port 60 corresponds to a different one color of the color ink. The second print head 6 discharges the color ink from the discharge port 60 toward the print medium 2 on the platen 3. As a result, color printing is performed on the print medium 2.

A discharge port 70 is provided on a lower surface of the pretreatment head 7. The discharge port 70 is configured such that a plurality of rows of a plurality of holes lined up in the sub-scanning direction are lined up in the main scanning direction. The pretreatment head 7 discharges a pretreatment agent 8 shown in FIG. 2 from the discharge port 70 toward the print medium 2 on the platen 3. As a result, the pretreatment agent 8 is applied to the print medium 2. Note that in FIG. 2, a pretreatment region 81 that is an application of the pretreatment agent 8 is indicated by hatching. The pretreatment agent 8 is a base coat agent to be applied to the print medium 2 before base printing, and improves the fixing of the white ink to the print medium 2 and the coloring of the color ink. One example of the pretreatment agent 8 is an aqueous solution that includes multivalent metal salt.

As illustrated in FIG. 1, the printer 1 is provided with a control board 10. A CPU 11, a ROM 12, and a RAM 13 are provided at the control board 10. The CPU 11 is electrically connected to the ROM 12, and the RAM 13, and controls the printer 1. The ROM 12 stores a control program for controlling operations of the printer 1, information necessary for the CPU 11 to execute various programs, and the like. The RAM 13 temporarily stores various data used in the control program, print data for performing the printing on the print medium 2, and the like.

A main scanning driver 21, a sub-scanning driver 22, a head driver 23, a heater 30, a humidity control device 31, a sensor 32, and an input portion 33 are electrically connected to the CPU 11. The main scanning driver 21 is formed by a motor or the like, and, when driven, moves the carriage 4 in the main scanning direction. The sub-scanning driver 22 is formed by a motor or the like, and, when driven, moves the platen 3 in the sub-scanning direction. As a result, the first print head 5, the second print head 6, and the pretreatment head 7 move relative to the platen 3 in the main scanning direction and the sub-scanning direction. The head driver 23 is formed by a pressure element or the like, and, when driven, causes the first print head 5 to discharge the white ink from the discharge port 50, causes the second print head 6 to discharge the color ink from the discharge port 60, or causes the pretreatment head 7 to discharge the pretreatment agent 8 from the discharge port 70.

The heater 30 and the humidity control device 31 are each provided inside the printer 1, and control the temperature and humidity, respectively, of a printing atmosphere. The printing atmosphere is the atmosphere of the space where printing is performed on the print medium 2. The sensor 32 is provided inside the printer 1 and includes a temperature sensor and a humidity sensor. The sensor 32 detects the temperature and humidity of the printing atmosphere, and outputs the detection results to the CPU 11. The CPU 11 can identify whether the each of the temperature and humidity are within a predetermined printing possible range based on the detection results from the sensor 32. The input portion 33 is operated by an operator and outputs a signal according to an operation to the CPU 11. The operator can input a print command to start printing, for example, to the printer 1 by operating the input portion 33.

Pretreatment and base printing will be described with reference to FIG. 2. The printer 1 performs a pretreatment before base printing. The printer 1 performs the pretreatment by discharging and applying the pretreatment agent 8 to the pretreatment region 81 from the discharge port 70 with the pretreatment head 7.

The printer 1 performs base printing by discharging white ink from the discharge port 50 of the first print head 5 onto a base region 91 and printing a base. The white ink is discharged on top of the pretreatment agent 8, so the size of the base region 91 is the same or smaller than the size of the pretreatment region 81. Note that, although not shown in the drawings, the printer 1 performs color printing after base printing, by discharging color ink from the discharge port 60 with the second print head 6 and printing a color image. The color ink is discharged on top of the white ink and the white ink is used as the base, so the size of the color region is the same or larger than the size of the base region 91.

An outline of the operation of the printer 1 in the pretreatment, base printing, and color printing will be described. Hereinafter, the first print head 5, the second print head 6, and the pretreatment head 7 will be collectively referred to as “heads”. The discharge ports 50, 60, and 70 will be collectively referred to as “discharge ports”. The ink and the pretreatment agent 8 will be collectively referred to as “droplets”.

In the pretreatment, base printing, and color printing, the main scanning processing and sub-scanning processing described below are repeatedly performed. In the main scanning processing, the head driver 23 is driven and droplets are discharged from the discharge ports toward the print medium 2 by the heads while the heads are moved, together with the carriage 4, in the main scanning direction with respect to the print medium 2 by the main scanning driver 21 being driven. In the sub-scanning processing, the sub-scanning driver 22 is driven and the print medium 2 on the platen 3 moves in the sub-scanning direction with respect to the heads.

The feature wherein in the pretreatment, the pretreatment agent 8 is discharged in the main scanning processing, in the base printing, the white ink is discharged in the main scanning processing, and in the color printing, the color ink is discharged in the main scanning processing, differs depending on the operations of the pretreatment, the base printing, and the color printing. As an example, when the white ink is discharged from the discharge port 50 by the first print head 5 in the base printing, dots 9 from the discharged white ink are formed on the print medium 2, as shown in FIG. 2.

Wet-on-wet printing will be described with reference to FIG. 2. In general, printing includes wet-on-wet printing and wet-on-dry printing. In the present embodiment, wet-on-wet printing refers to printing that is performed by white ink being discharged onto the print medium 2 that is wet with the pretreatment agent 8. Wet-on-dry printing refers to printing that is performed by white ink being discharged onto the print medium 2 that is not wet with the pretreatment agent 8 due to, for example, heat treatment having been performed or the pretreatment agent 8 having been left for an extended period of time. By performing wet-on-wet printing, the pretreatment agent 8, the ink, and the print medium 2 of the present embodiment sufficiently display the effect of the pretreatment agent 8 of improving the fixing of the white ink and the coloring of the color ink. Therefore, in the present embodiment, the base printing is performed by wet-on-wet printing.

When the pretreatment agent 8 is applied to the print medium 2 in the pretreatment region 81, the surface of the print medium 2 in the base region 91 is covered by the liquid surface of the applied pretreatment agent 8. The state wet with the pretreatment agent 8 is a state in which the entire surface of the print medium 2 in the base region 91 is covered by the liquid surface of the applied pretreatment agent 8.

As time passes, the pretreatment agent 8 applied to the print medium 2 evaporates from the surface of the print medium 2 and penetrates into the print medium 2 from the surface of the print medium 2. As time passes and the evaporation amount and penetration amount of the pretreatment agent 8 applied to the print medium 2 increase, the surface of the print medium 2 in the base region 91 is exposed from the liquid surface of the pretreatment agent 8. As a result, the print medium 2 changes from being wet with the pretreatment agent 8 to not being wet. That is, the state not wet with the pretreatment agent 8 is a state in which at least a portion of the surface of the print medium 2 in the base region 91 is essentially exposed from the liquid surface of the applied pretreatment agent 8. Note that there may be a case in which even if it is not actually wet with the pretreatment agent 8, the fibers of the surface of the print medium 2 are covered by the liquid surface of the pretreatment agent 8 due to the surface tension of the applied pretreatment agent 8. However, in any case, if the white ink is discharged after a predetermined period of time, set beforehand, or longer has passed after the pretreatment agent 8 is applied, printing will be performed in a non-wet state, so the effect of the pretreatment agent 8 will be unable to be sufficiently displayed.

If the time from the end of the application of the pretreatment agent 8 until the completion of the execution of the base printing is long, there may be a case in which, while the base printing is being executed, the print medium 2 becomes no longer wet with the pretreatment agent 8. In this case, the printer 1 changes to wet-on-dry printing midway through without completing the execution of wet-on-wet printing. Note that “completion of execution of wet-on-wet printing” refers to the execution of the base printing ending while the print medium 2 remains wet from the start to end of the base printing; for example, the white ink may be discharged within a predetermined period of time set beforehand, after the pretreatment agent 8 has been applied. When the base printing is performed as wet-on-dry printing, at the portion of the surface of the print medium 2 in the base region 91 that is exposed from the liquid surface of the pretreatment agent 8, there is a possibility that the effect of the pretreatment agent 8 may not be sufficiently displayed due to the white ink adhering directly to the fibers of the surface of the print medium 2, or the like, and the print quality will decrease. The printer 1 inhibits a decrease in print quality by executing main processing described below.

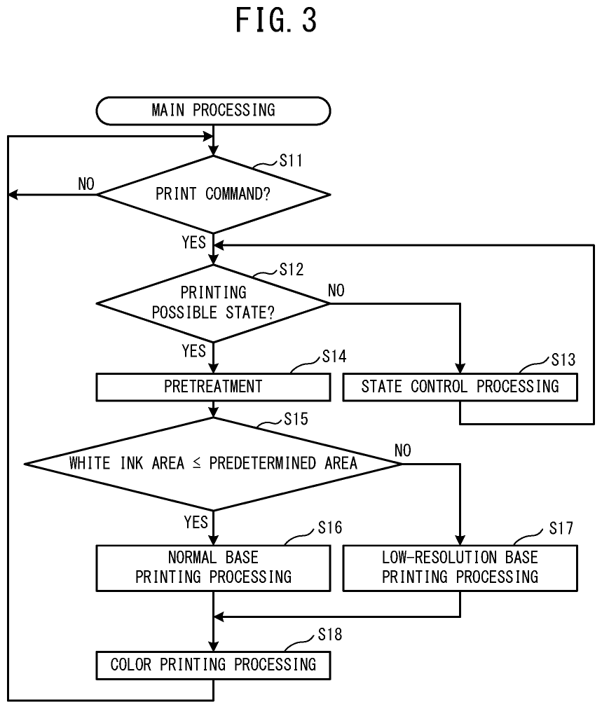

The main processing will be described with reference to FIG. 3. When the power supply of the printer 1 is turned on, the CPU 11 executes the main processing by reading out a control program from ROM 12 and operating. In the main processing, pretreatment, base printing processing, and color printing processing, and the like, are performed.

When the main processing starts, the CPU 11 determines whether a print command has been acquired via the input portion 33 (step S11). If a print command has not been acquired (no at step S11), the CPU 11 returns the processing to the determination at step S11. If a print command has been acquired (yes at step S11), the CPU 11 determines whether the execution of wet-on-wet printing is able to be completed, based on whether the state is a printing possible state or a printing prohibited state (step S12). The printing possible state is a state in which the base printing is possible. The printing prohibited state is a state in which the base printing is prohibited.

In the present embodiment, if at least one of either the temperature or the humidity is outside the printing possible range, or a maintenance operation is being performed, the state will be the printing prohibited state. The maintenance operations include, for example, white ink circulation, ink purging, ink flushing, wiping, ink being empty, or ink heating, or the like. White ink circulation is an operation that is performed in order to inhibit the white ink from settling. Ink purging is an operation that sucks in ink from outside the discharge ports 50 and 60 in order to remove impurities such as air, sediment, or aggregates from the ink. Ink flushing is an operation that discharges ink from the discharge ports 50 and 60 in advance so that ink can be appropriately discharged from the discharge ports 50 and 60 at the time of printing. Wiping is an operation that wipes off ink and the like that has adhered to the lower surface of the first print head 5 or the second print head 6 using a wiper (not shown in the drawings). Empty indicates a state in which there is no ink in a reservoir portion such as an ink tank, not shown. Ink heating is an operation that is performed by a heater (not shown in the drawings) in order to improve the fluidity of the ink.

If the state at the time of the determination at step S12 is the printing prohibited state, there is a possibility that the state will still be the printing prohibited state when the pretreatment (step S14) described later ends. Therefore, there is a possibility that it will take time from the time the pretreatment ends until the base printing processing (step S16 or S17), described later, starts. Therefore, if the state at the time of the determination at step S12 is the printing prohibited state, there is a possibility that execution of the wet-on-wet printing onto the print medium 2 to which the pretreatment agent 8 has been applied will not be able to be completed.

In the present embodiment, the determination at step S12 is made based on the state of a maintenance-in-progress flag and the detection results from the sensor 32. The maintenance-in-progress flag is stored in the RAM 13, and indicates whether a maintenance operation is being executed. The CPU 11 turns on the maintenance-in-progress flag when a maintenance operation starts, and turns off the maintenance-in-progress flag when the maintenance operation ends (not shown in the drawings). Information about the printing possible range is stored in the ROM 12. The CPU 11 compares the temperature and humidity of the printing atmosphere with the printing possible range based on the detection results from the sensor 32.

If at least one of the cases where the maintenance-in-progress flag is on, or the temperature or the humidity of the printing atmosphere is outside the printing possible range, the state will be the printing prohibited state, so the CPU 11 determines that execution of the wet-on-wet printing is unable to be completed (no at step S12). In this case, the CPU 11 executes state control processing in order to place the printer 1 into the printing possible state from the printing prohibited state (step S13). That is, the execution of pretreatment and base printing processing is prohibited until the printing possible state is established.

An example of the state control processing will be described. When the maintenance-in-process flag is on, the CPU 11 performs control to complete the maintenance operation. If the temperature or the humidity of the printing atmosphere is outside the printing possible range, the CPU 11 brings the temperature and the humidity of the printing atmosphere to within the printing possible range by controlling the heater 30 or the humidity control device 31 and heating, humidifying, or dehumidifying the printing atmosphere. In response to the processing at step S13, the maintenance-in-progress flag will turn off and the temperature and humidity of the printing atmosphere will come within the printing possible range. That is, the printer 1 will change from the printing prohibited state to the printing possible state. The CPU 11 then returns the processing to the determination at step S12.

When the maintenance-in-progress flag is off and the temperature and humidity of the printing atmosphere is within the printing possible range, the state is the printing possible state, so the CPU 11 determines that the execution of wet-on-wet printing is able to be completed (yes at step S12). In this case, the CPU 11 performs the pretreatment (step S14). In the pretreatment, the CPU 11 identifies the position of the pretreatment region 81 (refer to FIG. 2) with respect to the print medium 2, based on printing data. The CPU 11 repeats the main scanning processing and the sub-scanning processing. In the main scanning processing of the pretreatment, the CPU 11 controls the head driver 23 to cause the pretreatment head 7 to discharge the pretreatment agent 8 from the discharge port 70. As a result, the pretreatment agent 8 is applied to the print medium 2 in the identified pretreatment region 81 (refer to FIG. 2).

The CPU 11 determines whether execution of wet-on-wet printing is able to be completed, based on whether the white ink area is equal to or less than a predetermined area (step S15). The white ink area is the area of the base region 91 shown in FIG. 2, and is identified based on the printing data. The time required for base printing, i.e., the time that it takes from the start to the end of the discharge of the white ink from the discharge port 50 becomes longer the larger the white ink area is.

The predetermined area is stored beforehand in the ROM 12, and is designed based on the time that it takes for the print medium 2 to which the pretreatment agent 8 has been applied to change from a wet state to a non-wet state. This period of time is stored in the ROM 12, for example. The predetermined area in the present embodiment is equivalent to the maximum area for which execution of wet-on-wet printing is able to be completed; that is, is equivalent to the maximum area for which execution of normal base printing processing (step S16), described later, is able to be completed, within the time that it takes for the print medium 2 to which the pretreatment agent 8 has been applied to change from a wet state to a non-wet state.

If the white ink area is larger than the predetermined area, it may take a long time from the start of the normal base printing processing (step S16), described later, until completion. Therefore, if the white ink area is larger than the predetermined area, execution of wet-on-wet printing on the print medium 2 to which the pretreatment agent 8 has been applied may not be able to be completed.

If the white ink area is equal to or smaller than the predetermined area, the CPU 11 determines that the execution of wet-on-wet printing is able to be completed (yes at step S15). In this case, the CPU 11 performs the normal base printing processing (step S16). In normal base printing processing, the CPU 11 identifies the position of the base region 91 on the print medium 2 based on the printing data. The CPU 11 repeats the main scanning processing and the sub-scanning processing. In the main scanning processing of the normal base printing processing, the CPU 11 controls the head driver 23 to cause the first print head 5 to discharge the white ink from the discharge port 50. As a result, a base of a normal resolution is printed in the identified base region 91 (refer to FIG. 2). The normal resolution of the present embodiment is 1200 dpi. The CPU 11 then moves the process on to step S18.

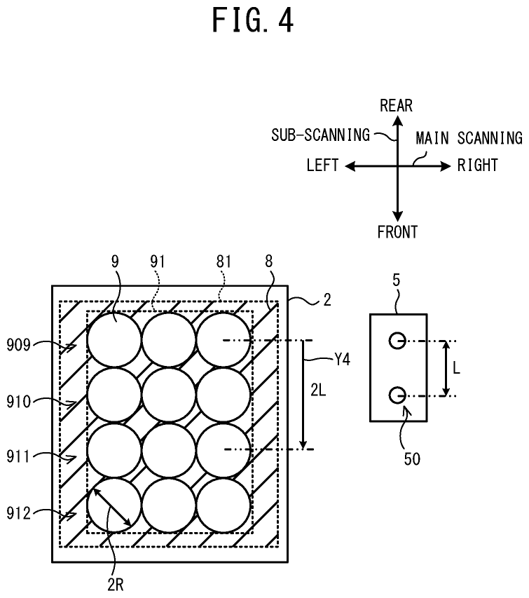

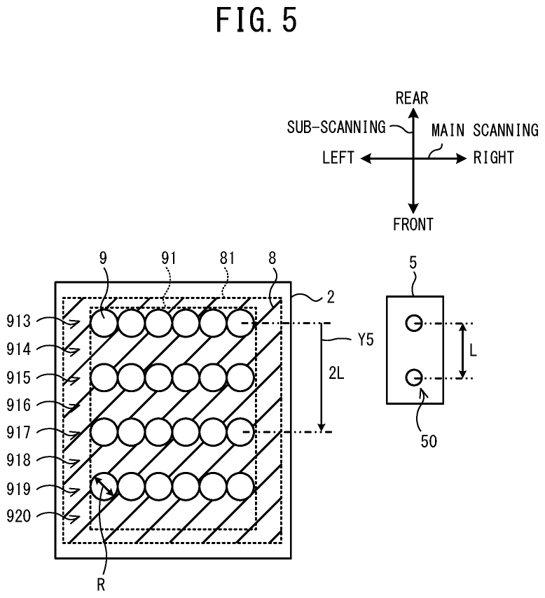

An example of a printing result of the normal base printing processing will be described with reference to FIG. 2. Hereinafter, in order to simplify the description, it will be assumed that the discharge port 50 is formed by two holes lined up in the sub-scanning direction, and the distance between the centers of these two holes is a distance L. In FIG. 2, the main scanning direction will be the left-right direction, and the sub-scanning direction will be the front-rear direction (the same also applies to FIG. 4 and FIG. 5 described later).

In the example in FIG. 2, the pressure applied to the discharged white ink is controlled by the head driver 23, and printing is performed such that the size of the diameter of the dots 9 will be the distance R. In a first main scanning processing, a row 901 that is the rearmost row, and a row 903 that is two rows in front of the row 901 are printed. In a first sub-scanning processing, the print medium 2 moves rearward by a distance L/2 with respect to the first print head 5 (refer to arrow Y1). Note that the arrow Y1 indicates the direction of relative movement of the first print head 5 with respect to the print medium 2 (the same also applies to arrows Y2 to Y5 described later). In a second main scanning processing, a row 902 that is one row in front of the row 901, and a row 904 that is two rows in front of the row 902 are printed.

In a second sub-scanning processing, the print medium 2 moves rearward by a distance 3L/2 with respect to the first print head 5 (refer to arrow Y2). In a third main scanning processing, a row 905 and a row 907 that is two rows in front of the row 905 are printed. In a third sub-scanning processing, the print medium 2 moves rearward by the distance L/2 with respect to the first print head 5 (refer to arrow Y3). In a fourth main scanning processing, a row 906 that is one row in front of the row 905, and a row 908 that is two rows in front of the row 906 are printed. As a result, base printing in the base region 91 is performed like the example shown in FIG. 2.

As shown in FIG. 3, if the white ink area is larger than the predetermined area, the CPU 11 determines that execution of the wet-on-wet printing is unable to be completed (no at step S15). In this case, the CPU 11 performs low-resolution base printing processing (step S17). In the low-resolution base printing processing, the CPU 11 identifies the position of the base region 91 on the print medium 2 based on the printing data. The CPU 11 repeats the main scanning processing and the sub-scanning processing. In the main scanning processing of the low-resolution base printing processing, the CPU 11 controls the head driver 23 to cause the first print head 5 to discharge the white ink from the discharge port 50. As a result, a low-resolution base is printed in the identified base region 91 (refer to FIG. 4). The low resolution is lower than the normal resolution, and in the present embodiment, is 600 dpi. The CPU 11 moves the processing on to step S18.

An example of a printing result of the low-resolution base printing processing will be described with reference to FIG. 4. The area of the base region 91 shown in FIG. 4 is the same as the area of the base region 91 shown in FIG. 2. In the example shown in FIG. 4, the pressure applied to the discharged white ink is controlled by the head driver 23, and printing is performed such that the size of the diameter of the dots 9 will be the distance 2R (twice the distance R). In the first main scanning processing, a row 909 that is the rearmost row, and a row 910 that is one row in front of the row 909 are printed. In the first sub-scanning processing, the print medium 2 moves rearward by a distance 2L with respect to the first print head 5 (refer to arrow Y4). In the second main scanning processing, a row 911 that is one row in front of the row 910, and a row 912 that is one row in front of the row 911 are printed. As a result, base printing in the base region 91 is performed like the example shown in FIG. 4.

As described above, the number of times sub-scanning processing is performed decreases as the resolution decreases, even if the area of the base region 91 is the same, such as three in the example shown in FIG. 2, and one in the example shown in FIG. 4. As a result, the time required for base printing is shorter in low-resolution base printing processing than it is in normal base printing processing.

As shown in FIG. 3, the CPU 11 performs color printing processing (step S18). In the color printing processing, the CPU 11 identifies the position of a color region (not shown in the drawings) on the print medium 2 based on the printing data. The CPU 11 repeats the main scanning processing and the sub-scanning processing. In the main scanning processing of the color printing processing, the CPU 11 controls the head driver 23 to cause the second print head 6 to discharge color ink from the discharge port 60. As a result, color printing is performed in the identified color region (not shown in the drawings). The CPU 11 returns the processing to the determination at step S11.

As described above, if it is determined that execution of wet-on-wet printing is able to be completed (yes at step S12 and yes at step S15), base printing in the normal base printing processing will be executed. On the other hand, if it is determined that wet-on-wet printing is unable to be executed (no at step S12 or no at step S15), the state control processing (step S15) or the low-resolution base printing processing (step S17) will be executed, so base printing with normal base printing processing (step S16) will not be executed. Therefore, the printer 1 easily completes execution of wet-on-wet printing. That is, with the printer 1, it is unlikely that base printing will be performed in a state in which the execution of wet-on-wet printing is unable to be completed. Therefore, it is possible to prevent a print result that is low-quality due to wet-on-wet printing not being executed, for example, from being created. As a result, the printer 1 is able to inhibit a decrease in print quality.

The CPU 11 determines at step S12 that execution of wet-on-wet printing is unable to be completed when in the printing prohibited state. Therefore, when in the printing prohibited state, base printing with normal base printing processing (step S16) will not be executed. Thus, the time from the end of the application of the pretreatment agent 8 in the pretreatment (step S14) until the start of base printing in the normal base printing processing (step S16) is inhibited from becoming long. Therefore, the time from the end of the application of the pretreatment agent 8 in the pretreatment until the end of the base printing in the normal base printing processing is inhibited from becoming long. Thus, the printer 1 can inhibit incomplete execution of wet-on-wet printing.

The CPU 11 prohibits, in the processing at step S13, execution of normal base printing processing until the printing possible state is established. Accordingly, unless the state is the printing possible state, base printing in the normal base printing processing will not be executed. Therefore, the printer 1 is further able to inhibit incomplete execution of wet-on-wet printing.

For example, if the white ink area is larger than the predetermined area, the time required for printing will be longer, so the evaporation amount and the penetration amount of the pretreatment agent 8 applied to the base region 91 will be greater. If the white ink area is larger than the predetermined area in the determination at step S15, the CPU 11 determines that execution of wet-on-wet printing is unable to be executed. In this case, base printing in the normal base printing processing will not be executed. Therefore, the printer 1 is able to inhibit the incomplete execution of wet-on-wet printing.

The CPU 11 performs base printing on the print medium 2 at normal resolution in the normal base printing processing (step S16). The CPU 11 performs printing on the print medium 2 at low resolution in the low-resolution base printing processing (step S17). The low resolution is lower than the normal resolution, so with the printer 1, the amount of time required for base printing in the low-resolution base printing processing can be made shorter than the amount of time required for printing in the normal base printing processing. Therefore, even if the white ink area is larger than the predetermined area, the time required for base printing can be inhibited from becoming long. Thus, the printer 1 is able to inhibit incomplete execution of wet-on-wet printing.

The present disclosure may be modified in various ways from the foregoing embodiment. The various modified examples described below can be combined as long as there are no contradictions. The CPU 11 may execute thinned-out base printing processing instead of the low-resolution base printing processing (step S17). In the thinned-out base printing processing, the CPU 11 identifies, based on the printing data, the position of the base region 91 with respect to the print medium 2. The CPU 11 repeats the main scanning processing and the sub-scanning processing. In the main scanning processing in the thinned-out base printing processing, the CPU 11 controls the head driver 23 to cause the first print head 5 to discharge the white ink from the discharge port 50. In this case, the CPU 11 causes the first print head 5 to discharge the white ink from the discharge port 50, thinning the discharge of white ink from the discharge port 50 by the first print head 5. As a result, a thinned-out base is printed in the identified base region 91 (refer to FIG. 5).

An example of a printing result of the thinned-out base printing processing will be described with reference to FIG. 5. The area of the base region 91 shown in FIG. 5 is the same as the area of the base region 91 shown in FIG. 2. In the example shown in FIG. 5, the pressure applied to the discharged white ink is controlled by the head driver 23, and printing is performed such that the size of the diameters of the dots 9 will be the distance R. In the first main scanning processing, a row 913 that is the rearmost row and a row 915 that is two rows in front of the row 913 are printed. In the first sub-scanning processing, the print medium 2 moves rearward by the distance 2L with respect to the first print head 5 (refer to arrow Y5).

In the second main scanning processing, a row 917 that is two rows in front of a row 950, and a row 919 that is two rows in front of the row 917 are printed. Base printing in the base region 91 is performed like the example shown in FIG. 5. In this way, printing is performed eliminating a row 914 that is one row in front of the row 913, a row 916 that is one row in front of the row 915, a row 918 that is one row in front of the row 917, and a row 920 that is one row in front of the row 919.

As described above, the number of times sub-scanning processing is performed decreases by the discharge of the white ink being thinned out, even if the area of the base region 91 is the same, such as three in the example shown in FIG. 2, and one in the example shown in FIG. 5. As a result, the time required for base printing is shorter in thinned-out base printing processing than it is in normal base printing processing.

According to the foregoing modified example, the number of times white ink is discharged is less in base printing in the thinned-out base printing processing than it is in base printing in the normal base printing processing, so with the printer 1, the time required for base printing in the thinned-out base printing processing can be made shorter than the time required for base printing in the normal base printing processing normal. Thus, even if the white ink area is larger than the predetermined area, the time required for base printing is inhibited from becoming longer. Therefore, the printer 1 can inhibit incomplete wet-on-wet printing.

Note that the direction in which discharge of the white ink from the discharge port 50 by the first print head 5 is thinned out in the thinned-out base printing processing is not limited to the sub-scanning direction. That is, the discharge of the white ink from the discharge port 50 by the first print head 5 may be thinned out in the main scanning direction, or it may be thinned out in both the main scanning direction and the sub-scanning direction.

The CPU 11 may repeatedly execute the thinned-out base printing processing. That is, in the example shown in FIG. 5, the CPU 11 may print the thinned-out base in the rows 914, 916, 918, and 920 of the base region 91 in the second thinned-out base printing processing, after first printing the thinned-out base in the rows 913, 915, and 917 in the first thinned-out base printing processing. In this case, the dots 9 formed by the first thinned-out base printing processing spread in the radial direction due to penetration of the white ink, that is, to the region (rows 914, 916, 918, 920) where discharge of the white ink was thinned out. As a result, wet-on-wet printing in the entire base region 91 is essentially completed by the first thinned-out base printing processing. Moreover, the amount of white ink that is discharged is compensated for by the second thinned-out base printing processing. Therefore, the printer 1 can complete wet-on-wet printing while increasing the concentration of white ink of the base, i.e., while improving the print quality, more than when the thinned-out base printing processing is performed only once.

In the foregoing embodiment, the predetermined area may be less than the maximum area where execution of the normal base printing processing (step S16) is able to be completed with the white ink, within the period of time from after the print medium 2 to which the pretreatment agent 8 has been applied changes from the wet state to the non-wet state, or may be larger than the maximum area. For example, if the predetermined area is less than the maximum area, the printer 1 can inhibit incomplete execution of wet-on-wet printing even if variation occurs in the evaporation amount and the penetration amount of the pretreatment agent 8 over time.

In the foregoing embodiment, the CPU 11 determined whether a maintenance operation is in progress by the state of the maintenance-in-progress flag. In contrast, the printer 1 may be provided with a sensor (not shown in the drawings) for detecting whether various maintenance operations are in progress, and the CPU 11 may determine whether a maintenance operation is in progress based on a signal from the sensor.

In the foregoing embodiment, the pretreatment head 7 is provided on the printer 1. In contrast, a printing system may be formed by the printer 1 and a pretreatment device (not shown in the drawings), and the pretreatment head 7 may be provided on the pretreatment device. In this case, the platen 3 may be able to move between the printer 1 and the pretreatment device. In the printing system, a control board may be provided in both the printer 1 and the pretreatment device, for example. Main processing may be distributed processing by the control boards communicating with each other. The printing system may further be provided with a server, and the main processing may be executed by the server. In this case, the server may send commands according to the various processing to the control boards, and the control boards may operate based on commands from the server. In this case, the processing at step S14 will be processing to convey the platen 3 to the pretreatment device. The pretreatment device need only execute pretreatment according to the detection of the platen 3 by a sensor (not shown in the drawings). When the pretreatment ends, the platen 3 is conveyed to the printer 1. The pretreatment device and the printer 1 need only be connected by a conveyance device such as a rail which is not shown in the drawings.

In the foregoing embodiment, in the normal base printing processing (step S16) and the low-resolution base printing processing (step S17), color ink may be used instead of white ink, and a color image of a plurality of colors may be printed instead of the base. The CPU 11 may omit the determination at step S12 and the processing at step S13, or may omit the determination at step S15 and the processing at step S17.

In the foregoing embodiment, the CPU 11 may determine whether the white ink area is larger than the predetermined area before the pretreatment (step S14). If the white ink area is equal to or smaller than the predetermined area (yes at step S15), the CPU 11 may perform the pretreatment (step S14), and the normal base printing processing (step S16) in that order, and if the white ink area is larger than the predetermined area (no at step S15), the CPU 11 may perform the pretreatment (step S14) and the low-resolution base printing processing (step S17) in that order.

In the foregoing embodiment, the CPU 11 may execute high-speed base printing processing instead of the low-resolution base printing processing. In the high-speed base printing processing, the CPU 11 controls the main scanning driver 21, the sub-scanning driver 22, and the head driver 23, to move the carriage 4 and the platen 3 faster than the movement speed of the carriage 4 and the platen 3 in the normal base printing processing to perform base printing without reducing the resolution. Therefore, with the high-speed base printing processing, the printer 1 can complete the execution of base printing in a shorter period of time than with the normal base printing processing, without reducing the resolution of the base. Generally, if the carriage 4 or the platen 3 is moved at a higher speed than normal, the landing accuracy of the droplets will decrease, but because white ink is used as the base, the landing accuracy does not have to be as high as it does with color ink. Accordingly, the printer 1 can complete wet-on-wet printing while inhibiting a decrease in print quality of the color image.

In the foregoing embodiment, the pretreatment agent 8 is applied to the print medium 2 by being discharged from the discharge port 60 by the pretreatment head 7. In contrast, the pretreatment agent 8 may be applied to the print medium 2 by being sprayed with a spray (not shown in the drawings), or may be applied to the print medium 2 with a spatula (not shown in the drawing) or the like.

The condition of the first print head 5 changing to the printing prohibited state is not limited to the foregoing embodiment. For example, if the relationship of the humidity with respect to the temperature of the printing atmosphere is outside a printing possible range, the first print head 5 may change to the printing prohibited state. If the temperature is not used and the humidity is outside the printing possible range, the first print head 5 may be changed to the printing prohibited state. In this case, the heater 30 and the temperature sensor need not be provided. If the humidity is not used and the temperature is outside the printing possible range, the first print head 5 may be changed to the printing prohibited state. In this case, the humidity control device 31 and the humidity sensor need not be provided. The first print head 5 may be changed to the printing prohibited state even if the atmospheric pressure in the printing atmosphere is outside the printing possible range.

The CPU 11 may determine, in the determination at step S12, whether the printing prohibited state is set, while the pretreatment (step S14) or the base printing processing (step S16 or step S17) is being executed. For example, if an appointment for executing a maintenance operation is set after a predetermined time, the CPU 11 may determine that the printing prohibited state is set.

In the foregoing embodiment, the CPU 11 identifies, based on the printing data, the white ink area and position of the pretreatment region 81 with respect to the print medium 2. In contrast, the white ink area and the position of the pretreatment region 81 with respect to the print medium 2 may be stored in the ROM 12 beforehand, or may be input to the printer 1 via the input portion 33 by the operator. In this case, the CPU 11 need only acquire the white ink area and the position of the pretreatment region 81 with respect to the print medium 2, from the ROM 12 or according to the operation of the input portion 33.

In the foregoing embodiment, after the low-resolution base printing processing (step S17) and before the color printing processing (step S18), the CPU 11 may further perform the normal base printing processing or the low-resolution base printing processing. In this case, a base will be further printed on the printed base with white ink. The first layer base is low resolution, so by printing the second layer base, the printer 1 can increase the density of the white ink of the base compared to when the base is only one layer. As a result, the printer 1 can improve the print quality.

The configurations of the discharge ports 50, 60, and 70 may be different from each other, and are not limited to the foregoing embodiment. For example, the discharge ports 50, 60, and 70 may each be formed by a row of holes lined up in the main scanning direction, or may be formed by a row of holes liked up in the sub-scanning direction, like a line head or the like. The discharge ports 50, 60, and 70 may each be formed by a single hole.

In the foregoing embodiment, the pretreatment agent 8 may display an effect other than improving the fixing of white ink and the coloring of color ink, such as improving fastness with respect to washing or friction or the like, or reducing bleed-through of the ink or the like.

In the first aspect to the third aspect of the present disclosure, the first processing may include processing to perform printing with ink after applying the pretreatment agent 8 to the pretreatment head 7.

In place of the CPU 11, a microcomputer, application specific integrated circuits (ASICs), a field programmable gate array (FPGA) or the like may be used as a processor. The main processing may be performed as distributed processing by a plurality of the processors. It is sufficient that the non-transitory storage media, such as the ROM 12, and the like be a storage medium capable of storing information, regardless of a period of storing the information. The non-transitory storage medium need not necessarily include a transitory storage medium (a transmitted signal, for example). The control program may be downloaded from a server connected to a network (not shown in the drawings) (in other words, may be transmitted as transmission signals), and may be stored in the ROM 12. In this case, the control program may be stored in a non-transitory storage medium, such as an HDD provided in the server.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A printer comprising:
a print head configured to discharge ink onto a print medium;
a processor configured to control the print head; and
a memory storing computer-readable instructions that, when executed by the processor, cause the processor to perform processes comprising:
performing determination processing of determining whether execution of wet-on-wet printing, which is printing wet-on-wet with the ink onto the print medium to which a pretreatment agent has been applied by a pretreatment portion applying the pretreatment agent to the print medium, is able to be completed;
performing first processing of printing with the ink by discharging the ink from the print head onto the pretreatment agent that has been applied to the print medium, when it has been determined by the determination processing that execution of the wet-on-wet printing is able to be completed; and
performing second processing differing from the first processing, when it has been determined by the determination processing that execution of the wet-on-wet printing is unable to be completed.

2. The printer according to claim 1, wherein
in the determination processing, the computer-readable instructions stored in the memory further cause the processor to perform a process comprising:
determining that execution of the wet-on-wet printing is unable to be completed when printing with the ink is prohibited.

3. The printer according to claim 2, wherein
in the second processing, the computer-readable instructions stored in the memory further cause the processor to perform a process comprising:
prohibiting execution of the first processing until printing with the ink becomes possible.

4. The printer according to claim 1, wherein
in the determination processing, the computer-readable instructions stored in the memory further cause the processor to perform a process comprising:
determining that execution of the wet-on-wet printing is unable to be completed when an area of a region to be printed by the first processing is larger than a predetermined area.

5. The printer according to claim 4, wherein
in the first processing, the computer-readable instructions stored in the memory further cause the processor to perform a process comprising:
performing printing onto the print medium at a first resolution; and
in the second processing, the computer-readable instructions stored in the memory further cause the processor to perform a process comprising:
performing printing onto the print medium at a second resolution which is lower than the first resolution.

6. The printer according to claim 4, wherein
in the second processing, the computer-readable instructions stored in the memory further cause the processor to perform a process comprising:
discharging the ink from the print head onto the pretreatment agent applied to the print medium while thinning out discharging of the ink from the print head.

7. A control method of a printer provided with a print head configured to discharge ink onto a print medium, and a processor configured to control the print head, the control method comprising:
performing determination processing of determining whether execution of wet-on-wet printing, which is printing wet-on-wet with the ink onto the print medium to which a pretreatment agent has been applied by a pretreatment portion applying the pretreatment agent to the print medium, is able to be completed;
performing first processing of printing with the ink by discharging the ink from the print head onto the pretreatment agent that has been applied to the print medium, when it has been determined by the determination processing that execution of the wet-on-wet printing is able to be completed; and
performing second processing differing from the first processing, when it has been determined by the determination processing that execution of the wet-on-wet printing is unable to be completed.

8. A non-transitory computer-readable medium storing computer-readable instructions that, when executed by a computer of a printer provided with a print head configured to discharge ink onto a print medium, and the computer configured to control the print head, cause the computer to perform processes comprising:
performing determination processing of determining whether execution of wet-on-wet printing, which is printing wet-on-wet with the ink onto the print medium to which a pretreatment agent has been applied by a pretreatment portion applying the pretreatment agent to the print medium, is able to be completed;
performing first processing of printing with the ink by discharging the ink from the print head onto the pretreatment agent that has been applied to the print medium, when it has been determined by the determination processing that execution of the wet-on-wet printing is able be completed; and
performing second processing differing from the first processing, when it has been determined by the determination processing that execution of the wet-on-wet printing is unable to be completed.
